(19) United States
(12) Patent Application Publication
(10) Pub. No.: US 2012/0025786 A1
(43) Pub. Date: Feb. 2, 2012

(54) BATTERY-CONTROLLED CHARGING OF A RECHARGEABLE BATTERY

(76) Inventors: Stephen D. Heizer, Houston, TX (US); Christopher K. Matthews, Spring, TX (US); John A. Wozniak, Houston, TX (US)

(21) Appl. No.: 13/259,423

(22) PCT Filed: Oct. 27, 2009
(86) PCT No.: PCT/US2009/062225

§ 371 Date: Sep. 23, 2011

(51) Int. Cl. H02J 7/00

(52) U.S. Cl. 320/160

(57) ABSTRACT

Methods and apparatus for recharging a rechargeable battery (202) having step charge requirements, where the charge current is tapered as successive voltage thresholds of the step charge requirements are approached. The battery (202) is programmed with a charge tapering algorithm, so that the battery charger (208) need not be programmed with battery-specific information. The charge tapering algorithm is used in conjunction with the step charge requirements and a measurement of one or more properties of the battery to determine an appropriate charge current as a function of time.

### BACKGROUND

Rechargeable batteries typically require some form of battery charging system. Battery charging systems transfer power from a power source, such as household AC power, into the battery. The recharging process generally includes regulating voltages and currents from the power source with a charger, so that the voltages and currents supplied to the battery meet the particular battery's charging specifications. For example, if the voltages or currents supplied to the battery are too large, the battery can be stressed or damaged.

On the other hand, if the voltages or currents supplied to a battery are too small, the charging process can be slow and inefficient. Additionally, if the charging process is not carried out efficiently, the battery's capacity may not be optimally used and its useful lifetime (i.e., the number of charge/discharge cycles available) may be reduced. These problems are compounded by the fact that battery characteristics, including specified voltages and recharge currents for the battery's cells, can be different from battery to battery.

Existing battery chargers are typically configured to receive power from a particular source and to provide voltages and currents to a particular battery based on the battery's charge specification. This may include, for example, stepping down the supplied charge current when predetermined battery voltages or temperatures are reached, to avoid overloading the battery. However, stepping down the charge current can lead to oscillations in both battery cell voltage and charge current during transitions between current levels, because a drop in battery voltage typically follows a drop in charge current due to the internal impedance of the battery cells.

More specifically, when a battery cell voltage reaches a threshold level and the charge current is decreased to avoid overloading the battery cell, the cell voltage will decrease slightly in response to the decreased current, falling below the threshold level and causing the charge current to jump back to its previous, higher value. This cycle of increasing and decreasing charge current and cell voltage may be repeated many times at each transition between current levels, resulting in undesirable stress on the battery and unnecessarily long charging time. Furthermore, the stress on the battery may result in a relatively short battery life.

One method of avoiding oscillations such as those described above is to lock the charge current at its reduced level after each new step, so that the current cannot jump back to its previous, higher value in response to a dip in battery voltage. However, although this method avoids oscillations, it typically significantly increases charging time. Another method of avoiding oscillations is to preprogram the charger with the charge requirements of the battery, and to reduce the supplied charge current gradually as each voltage or temperature step transition is approached. This avoids both oscillations and unwanted delays in charging, but requires the charger to have preexisting knowledge of the charge requirements of the battery. The charger is thus limited to known batteries at the time of charger design, and does not support future batteries with new requirements.

### BRIEF DESCRIPTION OF THE DRAWINGS

FIG. 1 is a flowchart depicting a method of charging a battery, in accordance with an embodiment of the invention.

FIG. 2 is a schematic block diagram depicting a battery charging system, in accordance with an embodiment of the invention.

FIG. 3 is a flowchart depicting an exemplary method of charging a battery to a plurality of voltage steps, in accordance with an embodiment of the invention.

FIG. 4 is a graph showing charge current and charge voltage versus time for a battery charged according to a prior art charging method.

FIG. 5 is a graph showing charge current and charge voltage versus time for a battery charged according to another prior art charging method.

FIG. 6 is a graph showing charge current and charge voltage versus time for a battery charged according to an embodiment of the invention

### DETAILED DESCRIPTION

The present teachings relate to methods and apparatus for charging rechargeable batteries. These teachings may be applied, for example, to batteries in laptop computers, cell phones, or any other electronic equipment that typically includes one or more rechargeable batteries. The disclosed teachings may be particularly suitable for use with lithium ion polymer batteries, but are also suitable for use with any other battery that is beneficially charged in a series of steps corresponding to different charge currents. The present teachings generally include programming a battery with a charge taper algorithm, in contrast to systems that either do not use a charge taper algorithm or that program a battery charger rather than a battery with a charge taper algorithm.

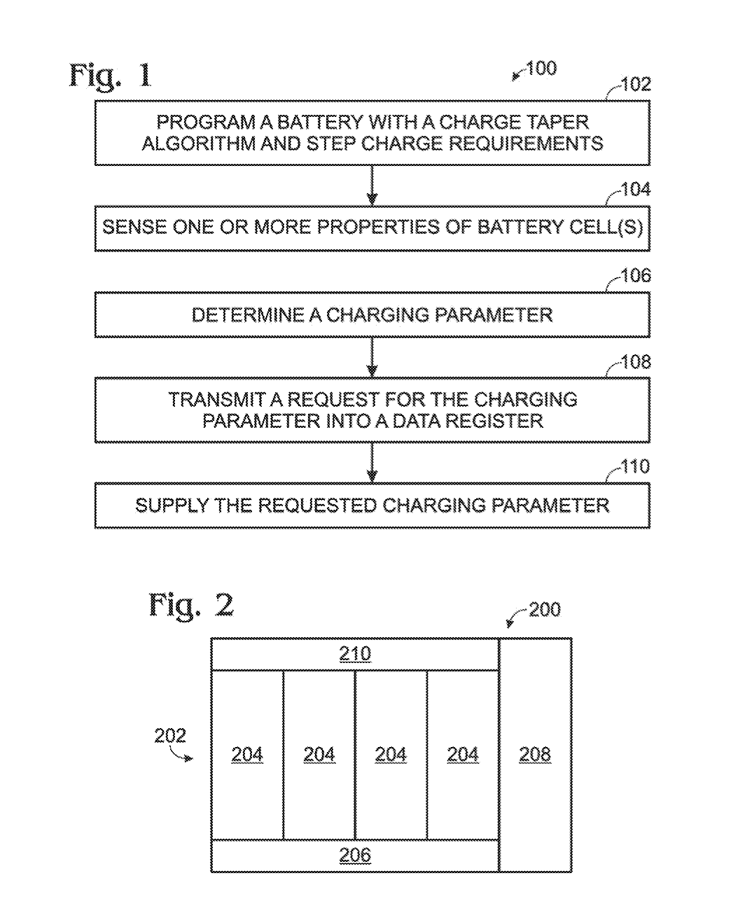

FIG. 1 depicts a method, generally indicated at 100, of charging a rechargeable battery according to aspects of the present teachings. At step 102, a battery including one or more battery cells is programmed with a charge taper algorithm and with step charge requirements corresponding to the cells of the battery. To accomplish such programming, the battery will generally include a programmable processor configured to receive and perform processing operations on data, and to receive and carry out processing instructions. For example, batteries conforming to the Smart Battery Data Specification promulgated by the Smart Battery System Implementers Forum may be suitable.

The step charge requirements programmed at step 102 will generally include a maximum desired charge current corresponding to each of several different ranges of battery cell voltage and/or temperature. The maximum voltage or temperature of each range may be characterized as a threshold or “trigger point” value, because exceeding this value triggers a different maximum desired charge current. Generally, the maximum desired charge current decreases as cell voltage and temperature increase, to limit stress on the battery during charging by controlling the charging rate and temperature. This may be especially important as the cell voltage approaches its maximum capacity. The step charge requirements are typically chosen to extend the life of the battery without excessively compromising charging speed. Accordingly, step charge requirements generally vary from battery to battery, depending at least in part on the cell chemistry, and may evolve over time as battery research and development evolves.

The charge taper algorithm programmed in step 102 is used in conjunction with the step charge requirements to help determine an appropriate charging parameter, including the charge current and/or the charge voltage, to be supplied to the battery. Because the charge current I and charge voltage V are related through Ohm's Law:

$$I = \frac{V}{Z} ,$$

where Z is the battery impedance, determining one of these charging parameters also determines the other. Furthermore, Ohm's Law may be used to determine a charge current from a measured value of impedance and a voltage. In any case, applying the charge taper algorithm will typically result in a progressive decrease in the supplied charge current so as to reduce the rate of increase of the voltage of each battery cell whenever a predetermined threshold value of the voltage and/or temperature of the battery cell is approached.

By tapering the supplied charge current in the manner described above, the charge taper algorithm may be configured to maintain the voltage and/or temperature of the battery cells below each successive voltage or temperature trigger point until the charge current has been reduced below a predetermined threshold. At that point, the charge current can be held constant and the charge voltage and/or cell temperature can be allowed to increase more rapidly until another trigger point is approached. As described in more detail below, tapering the charge current in this manner can avoid various undesirable effects that occur in the absence of charge tapering.

At step 104, a property of one or more of the battery cells is sensed or measured, so that the charge taper algorithm and step charge requirements can be applied. The measured property will typically be charge current, battery cell voltage, battery cell impedance and/or battery cell temperature. Accordingly, at least one current sensor, voltage sensor, impedance sensor and/or temperature sensor will typically be incorporated into or otherwise associated with the battery, to monitor the corresponding property of at least one of the battery cells. In some cases, two or more properties may be monitored simultaneously with appropriate sensors.

Suitable sensors may take various forms, generally including appropriately designed integrated circuits of which many types are commercially available. For example, cell voltages may be measured with a first integrated circuit, and cell temperature, charge current, and/or cell impedance may be measured with a second “fuel gauge” integrated circuit connected to the first circuit. Suitable fuel gauge circuits include part numbers BQ2084, BQ20Z40, BQ20Z45, BQ20Z60, BQ20Z65, BQ20Z70, BQ20Z75, BQ20Z90, and BQ20Z95, all sold by Texas Instruments, Inc. of Dallas, Tex. The measured property or properties of the battery cell may be digitized with an analog-to-digital converter, to be transmitted in digital form to a processor.

At step 106, a desired charging parameter such as charge current or charge voltage is determined based on the measured property of the battery cell(s), the step charge requirements, and the charge taper algorithm. Typically, the desired charging parameter will initially be set to provide a maximum charge current corresponding to the range in which the measured property lies, until the measured property approaches to within a predetermined offset value of a threshold or trigger point value. For example, if the maximum preferred charge current for a cell charged to between 3.0 and 4.0 volts (V) is 1400 milliamps (mA), then the charging parameter may be set to provide 1400 mA of charge current when a cell voltage of 3.0 V is measured, and this charge current may be maintained until the cell voltage approaches to within a predetermined amount of 4.0 V, such as a value of 3.9 or 3.95 V.

Continuing the previous example, when the cell voltage reaches 4.0 V minus some predetermined offset amount (such as 0.1 V or 0.05 V), the charging parameter may be adjusted to reduce the charge current and to maintain the cell voltage below 4.0 V, until the charge current drops below a predetermined threshold that corresponds to the maximum preferred charge current for a cell charged to 4.0 V. The charge current may be reduced in various ways to maintain the cell voltage in a particular range, and the precise tapering algorithm may depend on the battery cell chemistry. For example, in some applications the charge current may be reduced at an approximately linear average rate (as a function of time) to maintain the cell voltage below a trigger point value. This reduction will typically be performed as a series of discrete steps that are carried out at predetermined time intervals.

At step 108, the battery processor transmits a request to receive the charge current and charge voltage determined in step 106 from a battery charger, typically by transmitting the requested value or values into a data register accessible by the charger. The battery processor periodically updates the request (again, typically by periodically updating a suitable data register) so that the charger can supply a charge current consistent with the charge taper algorithm. The frequency of the updates can be selected to have any desired value, resulting in a charge current that responds to the changing battery cell properties at any desired rate.

At step 110, the charger supplies the requested charge current and charge voltage. Because the step charge requirements and the charge taper algorithm are maintained in the battery, the charger need not be programmed with any battery-specific information to do this. In some cases, the charger will support the changes in requested charge current and charge voltage, so that it can supply substantially exactly the requested values. In other cases, the charger may not support the changes in requested charge current and charge voltage. In such cases, the charger still may act as the power source for supplying the requested charge current and charge voltage, but the battery may incorporate circuits to internally control the charge current and voltage supplied by the charger, to bring them substantially to the requested values.

FIG. 2 is a block diagram schematically depicting the components of a battery charging system, generally indicated at 200, according to aspects of the present teachings. System 200 includes a charger 208 configured to supply a charge current and a charge voltage, a battery 202 having at least one battery cell 204, a sensor 206 configured to measure a property of the battery cell such as its voltage or temperature, and a programmable processor 210.

Battery 202 may include a plurality of battery cells 204, which typically will share similar characteristics. For example, the cells may be lithium ion cells having a maximum rated voltage of 4.2 volts, with various desired maximum charging currents corresponding to different cell voltage ranges. More generally, the cells may have any characteristics suitable for charging in a series of steps having different charge currents and/or voltages. As described previously, battery 202 also will include a programmable processor 210 capable of receiving and storing data, and of being programmed with and carrying out instructions. Accordingly, the processor may include associated memory and input/output devices and connections.

Processor 210 of battery 202 may be programmed in various ways consistent with the present teachings. Typically, the processor will be programmed with a charge taper algorithm, step charge requirements corresponding to one or more of cells 204, and instructions to determine a charge current and/or a charge voltage based on a measured property of the cell, the charge taper algorithm, and the step charge requirements. For example, according to the charge taper algorithm, the processor may be configured to taper a requested charge current from its maximum within a certain cell voltage range, to maintain a voltage of each cell 204 below a trigger point of the voltage corresponding to the maximum voltage of that particular range. This charge current tapering may continue until the charge current drops below a predetermined threshold value corresponding to the minimum voltage of the subsequent voltage range. The current then may be held constant, to allow the cell voltage to increase more rapidly toward the next trigger point.

Sensor 206 will typically be configured to measure at least one of charge current, cell voltage, cell temperature, or cell impedance corresponding to one or more of battery cells 204. As described previously, sensor 206 may include one or more connected integrated circuits, such as a voltage sensor circuit and a fuel gauge circuit, configured to measure different parameters simultaneously or in series. Sensor 206 is configured to communicate its measurements to processor 210, and in some cases may be incorporated within or integrated with processor 210.

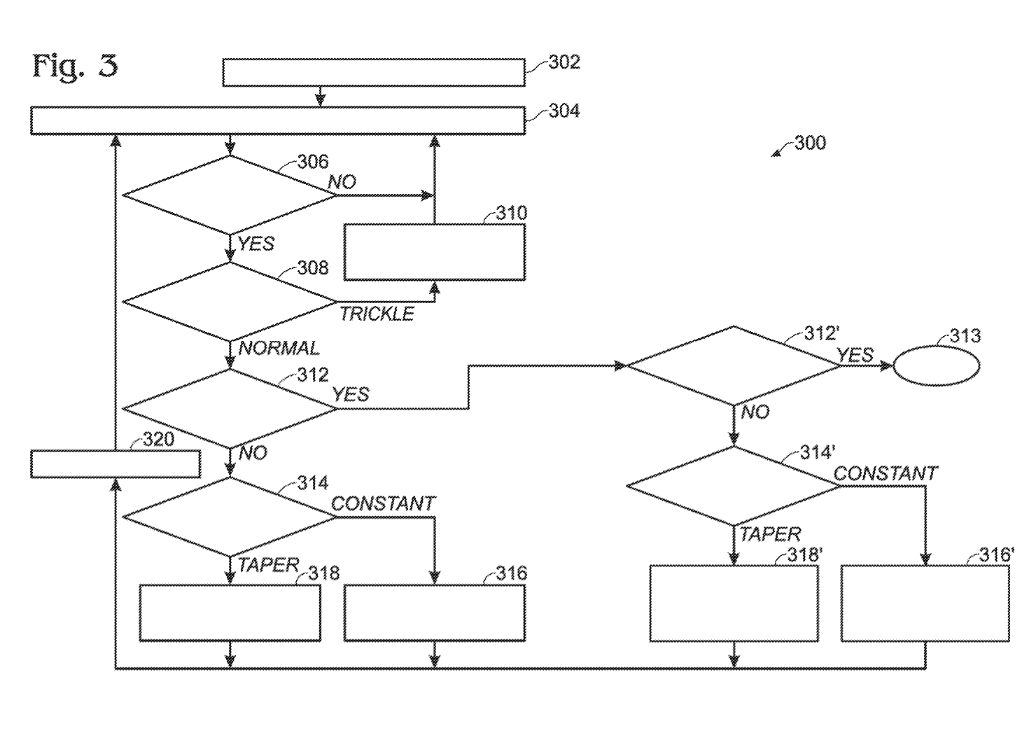

FIG. 3 is a flowchart depicting additional details of an exemplary process, generally indicated at 300, for charging a battery according to aspects of the present teachings. At step 302, a battery is connected to a charger, typically by inserting the battery into an electronic device such as a laptop computer or a cell phone. At step 304, one or more properties, such as voltage, temperature, and/or impedance of at least one of the battery cells is measured. At step 306, a determination is made as to whether charging of the battery will be allowed. For example, if the battery is fully charged or if the temperature exceeds some maximum permissible value, charging may not be allowed until the battery is discharged or the temperature drops, so the process returns to step 304 for another measurement. If charging is allowed, the process continues to step 308.

At step 308, a determination is made as to whether the battery is in normal or trickle charge range. Typically, the battery will be considered in trickle charge range if the cell voltage is under a predetermined minimum value, or if the temperature is within a predetermined range. If the battery is in trickle charge range, the charge current and voltage are set to their respective trickle charge values at step 310, and the process returns to step 304 for another measurement. This cycle will continue until the battery reaches its normal charging range. Once the battery is in normal charge range, the charging process continues to step 312.

At step 312, a determination is made as to whether the cell voltage exceeds a first maximum threshold value, i.e., a first voltage step trigger value. If the cell voltage exceeds this first threshold, then a determination is made as to whether the cell voltage also exceeds each subsequent threshold value, as generally indicated at step 312′. If the cell voltage exceeds all of the voltage threshold values, this indicates that the battery is overcharged, and accordingly an error is reported at step 313.

If the cell voltage does not exceed the first threshold voltage step value at step 312, then a determination is made at step 314 as to whether the cell voltage is close enough to the first threshold value to be in taper charge current range, or far enough from the first threshold value to be in constant charge current range. If the cell voltage is found to exceed the first threshold value at step 312, then a similar determination is made with respect to whichever voltage threshold value the measured cell voltage is closest to, as generally indicated at step 314′.

If the cell voltage is found at one of steps 314, 314′ to be far enough from a particular threshold value to be in constant current range, then at a related step 316, 316′, the charge current and voltage are set to the maximum values corresponding to the particular voltage range the cell is in. If, on the other hand, the cell voltage is found at one of steps 314, 314′ to be close enough to a particular threshold value to be in taper charge current range, then at a related step 318, 318′, the charge current and voltage are tapered according to a charge taper algorithm. Following any of steps 316, 316′, 318, 318′ (i.e., after an appropriate charge current and voltage have been determined), a charge parameter data register accessible by the battery charger is updated at step 320, and the process returns to step 304 for another measurement of one or more cell properties.

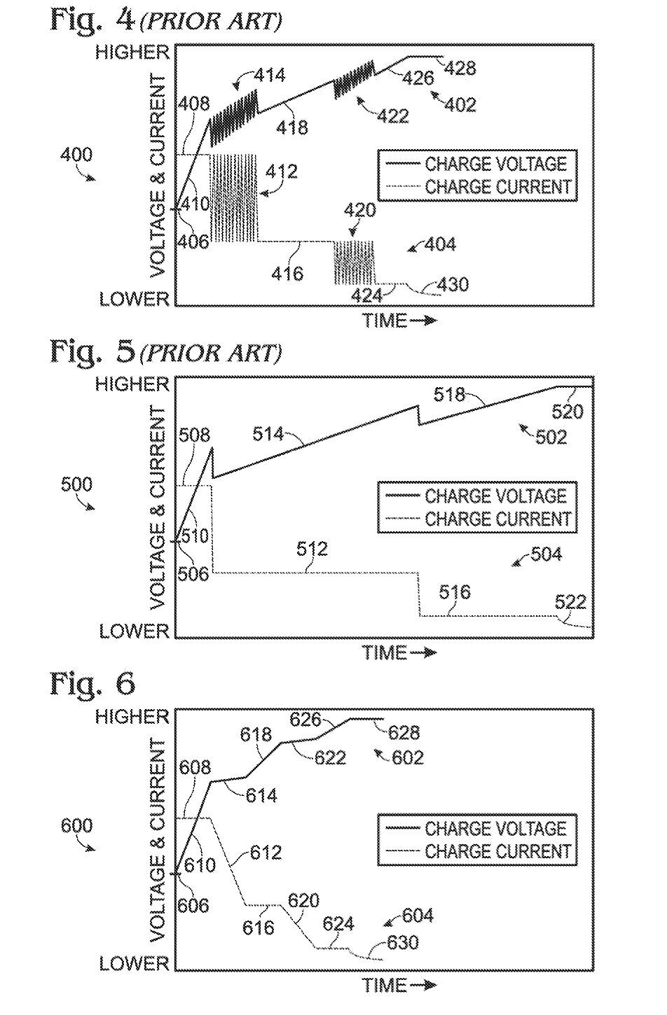

FIG. 4 depicts a graph, generally indicated at 400, of charge voltage and charge current versus time for a first prior art battery charging method. Specifically, lines 402 and 404 depict charge voltage and charge current versus time, respectively, for a battery charged according to a prior art method that does not use charge tapering. According to the charging method represented in FIG. 4, a battery cell voltage is measured to have an initial value, as indicated at 406. This initial cell voltage is substantially less than the maximum voltage supported by each battery cell, indicating that the battery is in a depleted condition and may be charged.

In the method represented in FIG. 4, the charging process begins by supplying a constant charge current to the battery, as indicated at 408. This current will typically be the maximum charging current suitable for the range in which the initial cell voltage lies. This constant charging current results in a substantially linear increase in cell voltage, as indicated at 410. When the cell voltage reaches a first threshold value, the charge current is decreased rapidly to a substantially lower value. Due to the cell impedance, this results in a rapid decrease in cell voltage, bringing the voltage back below the first threshold value and causing the current to be increased again to its higher value. This current increase causes a corresponding voltage increase, which causes a current decrease, and so forth. The result is oscillations in both charge current and cell voltage, as indicated at 412 and 414 respectively. These oscillations cause stress on the battery and increase charging time relative to the method of the present teachings.

Still with respect to the charging method represented in FIG. 4, eventually the lower value of the oscillatory cell voltage exceeds the first threshold value of voltage, and the charge current is maintained at its lower value as indicated at 416. This also allows the cell voltage to stop oscillating and to increase steadily, as indicated at 418. However, when the voltage reaches a second threshold level, both the charge current and cell voltage will again begin to oscillate, as indicated at 420, 422 respectively. When the lower value of the oscillatory cell voltage exceeds the second threshold, the charge current will remain constant at its lower value and the cell voltage will again increase steadily, as indicated at 424, 426 respectively. When the cell voltage reaches a maximum value as indicated at 428, the charge current will be decreased toward zero current as indicated at 430.

FIG. 5 depicts a graph, generally indicated at 500, of charge voltage and charge current versus time for a second prior art battery charging method. Specifically, lines 502 and 504 depict charge voltage and charge current versus time, respectively, for a battery charged according to another previously known method. According to this method, a battery cell voltage is measured to have an initial value, as indicated at 506, which is the same as value 406 measured in the method represented in FIG. 4. Accordingly, the initial cell voltage is substantially less than the maximum voltage supported by each battery cell, indicating that the battery is in a depleted condition and may be charged.

The charging process represented in FIG. 5 begins by supplying a constant charge current to the battery, as indicated at 508. This current will typically be the maximum charging current suitable for the range in which the initial cell voltage lies. This constant charging current results in a substantially linear increase in cell voltage, as indicated at 510. When the cell voltage reaches a first threshold value, the charge current is decreased rapidly to a substantially lower value. Due to the cell impedance, this results in a rapid decrease in cell voltage, bringing the voltage back below the first threshold value. All of this is the same as in the method depicted in FIG. 4. According to the method of FIG. 5, however, the charge current is locked into its lower value by hysteresis, as indicated at 512. This prevents oscillations of cell voltage and leads to a steady increase in the voltage, as indicated at 514.

Still with respect to FIG. 5, the lower charge current indicated at 512 is maintained until a second voltage threshold value is reached, at which point the charge current again quickly drops to a lower value, causing the cell voltage to drop due to the cell impedance. The lower charge current value is maintained, as indicated at 516, as the cell voltage increases toward its maximum, as indicated at 518. When the cell voltage reaches a maximum value as indicated at 520, the charge current will be decreased toward zero current as indicated at 522.

FIG. 6 depicts a graph, generally indicated at 600, of charge voltage and charge current versus time for a battery charging method according to the present teachings. Specifically, lines 602 and 604 depict charge voltage and charge current versus time, respectively, for a battery charged according to a method that includes charge tapering. According to this method, a battery cell voltage is again measured to have an initial value indicated at 606 which is less than the maximum voltage supported by the cell, indicating that the battery is may be charged. As in the methods of FIGS. 4-5, a constant charge current is supplied to the battery, as indicated at 608, resulting in an increase in cell voltage, as indicated at 610.

In contrast to both of the previously described charging methods, the initial charge current in the method represented in FIG. 6 is maintained at a constant value until the cell voltage approaches to within a predetermined offset amount from a first voltage threshold or trigger value, at which point the charge current is tapered or reduced as indicated at 612. This causes the charge voltage to increase at a substantially reduced rate, as indicated at 614. In some cases (not shown in FIG. 6), tapering the charge current may cause the voltage to become constant or to decrease for some amount of time, rather than merely to increase at a reduced rate. Charge current tapering continues until the current reaches a value that is permissible for voltages above the first voltage trigger value. At this point, the current is maintained at a constant value as indicated at 616, and the voltage increases more rapidly, as indicated at 618.

Still according to the present teachings, and as depicted in FIG. 6, when the cell voltage reaches a predetermined offset amount from a second voltage threshold or trigger value, the charge current is again tapered, as indicated at 620. This again results in a substantial reduction in the rate of increase of the charge voltage, as indicated at 622. When the current reaches a value suitable for voltages above the second voltage threshold, the charge current is maintained at a constant value as indicated at 624, and the charge voltage increases more rapidly as indicated at 626.

The above-described cycle of charging a battery at a constant charge current and then a tapering charge current may be repeated any desired number of times and with any desired voltage threshold values, offset values, charge current values and charge current tapering rates, according to the step charge requirements of a particular battery. Eventually, when the cell voltage nears a maximum value as indicated at 628, the charge current will be decreased toward zero current as indicated at 630. This may be done gradually, either as part of the tapering algorithm or as an inherent feature of the battery nearing its full charge, to avoid undesirable corresponding decreases in cell voltage due to the internal cell impedance.

In comparison to the charging methods depicted in FIGS. 4-5, the method depicted in FIG. 6 avoids unwanted oscillations in charge current and cell voltage (as in the method depicted in FIG. 4), and also avoids unwanted delays in charging due to forcing the charger to maintain an unnecessarily low charge current (as in the method depicted in FIG. 5). In addition, as described previously, the present teachings contemplate programming the battery itself, rather than the charger, with a charge tapering algorithm, so that a charger need not include any battery-specific information to function in accordance with the presently disclosed methods.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

We claim:

1. A method (100) of charging a battery, comprising:
programming (102) a battery with a charge taper algorithm and with step charge requirements corresponding to at least one cell of the battery;
sensing (104) a property of the cell;
determining (106) a charging parameter based on the sensed property, the step charge requirements, and the charge taper algorithm; and
supplying (110) the charging parameter to the battery with a charger.

2. The method of claim 1, wherein the charge taper algorithm is configured to maintain the property of the cell below a trigger point until charge current drops below a predetermined threshold.

3. The method of claim 1, further comprising transmitting (108) a request for the determined charging parameter into a data register accessible by the charger.

4. The method of claim 1, wherein the charging parameter is charge current or charge voltage.

5. The method of claim 1, wherein the sensed property of the cell is selected from the group consisting of voltage, impedance, current and temperature.

6. The method of claim 1, further comprising controlling the charging parameter supplied by the charger with the battery.

7. A battery charging system (200), comprising:
a battery (202) programmed with:
a charge taper algorithm;
step charge requirements corresponding to at least one cell (204) of the battery (202); and
instructions to determine a charging parameter based on a measured property of the cell, the charge taper algorithm, and the step charge requirements;
a sensor (206) configured to measure the property of the cell; and
a charger (208) configured to supply the charging parameter to the battery.

8. The system of claim 7, wherein the instructions include instructions to taper charge current to maintain the property of the cell (204) below a trigger point until the charge current drops below a predetermined threshold.

9. The system of claim 7, wherein the charging parameter is charge current or charge voltage.

10. The system of claim 7, wherein the measured property is selected from the group consisting of voltage, impedance, current and temperature.

11. The system of claim 7, wherein the battery (202) is configured to transmit a request for the charging parameter into a data register accessible by the charger (208).

12. The system of claim 7, wherein the battery (202) is configured to control the charging parameter supplied by the charger (208).

13. A rechargeable battery (202), comprising:
at least one cell (204);
a sensor (206) configured to measure a property of the cell (204); and
a processor (210) programmed with step charge requirements of the cell (204), a charge current tapering algorithm, and instructions to determine a charging parameter selected from the group consisting of charge current and charge voltage based on the step charge requirements, the measured property, and the charge current tapering algorithm.

14. The battery (202) of claim 13, wherein the charge current tapering algorithm is configured to maintain the property of the cell (204) below a trigger point until the charge current drops below a predetermined threshold.

15. The battery (202) of claim 14, wherein the measured property is selected from the group consisting of voltage, impedance, current and temperature.
